(19) United States
(12) Patent Application Publication
(10) Pub. No.: US 2024/0102424 A1
(43) Pub. Date: Mar. 28, 2024

(54) PISTON-OPERATED VARIABLE VALVE DEVICE AND A VARIABLE VALVE SYSTEM HAVING THE SAME

(71) Applicants: HYUNDAI MOTOR COMPANY, Seoul (KR); KIA CORPORATION, Seoul (KR)

(72) Inventor: Kyung-Ryull Kim, Seoul (KR)

(73) Assignees: HYUNDAI MOTOR COMPANY, Seoul (KR); KIA CORPORATION, Seoul (KR)

(21) Appl. No.: 18/210,340

(22) Filed: Jun. 15, 2023

(30) Foreign Application Priority Data
Sep. 26, 2022 (KR) 10-2022-0121822

(51) Int. Cl. F02D 13/02

(52) U.S. Cl. CPC F02D 13/0249

(57) ABSTRACT

A variable valve device includes: a cam having profiles with different exhaust valve opening and closing timings, a rocker arm, and a socket having a piston. In particular, an exhaust valve is connected to a valve bridge and the piston vertically moves by oil pressure supplied to an inside of the socket. When the piston protrudes downward from the socket, the rocker arm and the cam come into contact with each other, and the exhaust valve is opened and closed by the cam profiles.

### CROSS-REFERENCE TO RELATED APPLICATION

This application claims priority to Korean Patent Application No. 10-2022-0121822, filed on Sep. 26, 2022, the entire contents of which are incorporated herein by reference.

### BACKGROUND

### Field

The present disclosure relates to a variable valve device, and particularly, to a variable valve system which adopts a variable valve mechanism in which the motion of a rocker arm for the contact with cam profiles are generated by the pop up motion of a piston applying a force upward from the rocker arm.

### Description of Related Art

In general, a variable valve system of a vehicle increases an exhaust temperature under a specific vehicle driving condition to assist the performance of an exhaust purification device configured to decrease an exhaust gas of an engine.

This is because the exhaust purification device requires an exhaust gas with a certain temperature or higher in order to effectively activate exhaust purification efficiency. A large amount of harmful exhaust gases is emitted due to a decrease or loss of the purification ability of the exhaust purification device in an area where the exhaust temperature is low or when an exhaust temperature is low while a vehicle is operated as in the early stage of engine start.

Therefore, the variable valve system increases the exhaust temperature to shorten a light-off time (LoT), which is a time to reach a catalyst activation temperature of the exhaust purification system. To this end, the variable valve system includes a rocker arm device interlocked with a cam shaft, a variable valve device configured to perform a variable valve lift (VVL)/continuously variable valve time (CVVT)/continuous variable valve lift (CVVL) for a valve, an oil control circuit configured to control oil flow by an oil control valve (OCV).

For example, the variable valve device operates in an operation area where an increase in the exhaust gas temperature is required (i.e., an area where the exhaust temperature is low) to advance an exhaust valve opening time or retard an exhaust valve closing time so that the exhaust gas temperature is increased in a desired operation condition, thereby shortening the time to reach the catalyst activation temperature (LoT).

The exhaust valve opening advance causes the exhaust temperature to increase due to the discharge of a high-temperature combustion gas during an explosion stroke, and the exhaust valve closing retardation increases a flow rate of an internal exhaust gas recirculation (EGR) due to an increase in an overlapping section of an exhaust valve and an intake valve to increase an intake temperature, thereby contributing to increasing the exhaust gas.

To this end, the variable valve device may include, for example, a cam phasing type variable valve device or a cam in cam type variable valve device.

However, the cam phasing type or cam in cam type variable valve device has a limitation in that the closing time retardation is impossible in the opening time advance in a single overhead camshaft (SOHC), and in particular, an undesired advance is possible upon variable operation.

In particular, the cam phasing type variable valve device is installed at a front end of the camshaft to implement the opening advance and the closing retardation by shifting a valve profile.

In addition, the cam in cam type variable valve device is a type which is divided into a first cam and a first rocker arm having profiles of the opening advance and a second cam and a second rocker arm having profiles of the closing retardation and implements the opening advance and the closing retardation by constituting a pair of the first and second cams and a pair of the first and second rocker arms and matching them with each of the exhaust valves applied to the engine.

Therefore, the cam phasing type variable valve device and the cam in cam type variable valve device are variable valve devices having complicated configurations, thereby facing a cost increase problem.

The statements in this BACKGROUND section merely provide background information related to the present disclosure and may not constitute prior art.

### SUMMARY OF THE DISCLOSURE

An object of the present disclosure considering the above point is to provide a piston-operated (e.g., a piston pop up type) variable valve device and a variable valve system having the variable valve device. In particular, the variable valve system includes a roller of a rocker arm that comes into contact with cam profiles of a cam by the movement of a piston configured to apply a force upward from the rocker arm to implement opening advance and closing retardation, thereby maximizing an increase in an exhaust temperature due to the advance and retardation continuously performed in one operation. In particular, the oil causing the motion of the piston is naturally discharged from an inner space of a socket by the force of gravity even without separate relief valve, thereby significantly decreasing cost increase factors without additionally constituting the cam and the rocker arm.

In one aspect of the present disclosure, a variable valve device includes: a cam having profiles with different exhaust valve opening and closing timings, a rocker arm, and a socket having a piston, wherein an exhaust valve is connected to a valve bridge, the piston vertically moves by oil pressure supplied to the inside of the socket. When the piston protrudes downward from the socket, the rocker arm and the cam come into contact with each other, and the exhaust valve is opened and closed by the predetermined cam profiles.

As an embodiment, the oil pressure may be set to be greater than an elastic force of a bias spring pressing the rocker arm and smaller than an elastic force of a valve spring configured to support the valve bridge.

In one embodiment, the socket may form a socket inner space in which the oil pressure is generated.

In one embodiment, the socket inner space may be divided into an oil supply hole receiving the oil from the rocker arm, a piston movement hole, and a socket chamber, the piston movement hole may function as a passage into which the piston is inserted, and the socket chamber may form a space in which the oil pressure is generated by communicating with the oil supply hole having a funnel-shaped open structure, and the piston may receive the oil pressure and thus the piston moves downward from the socket.

In one embodiment, the socket chamber may be formed with a diameter greater than that of the piston movement hole, and may communicate with the oil supply hole at the top of the piston movement hole.

In one embodiment, the piston movement hole may form a gap with the piston, and the gap may function to allow the oil filled in the socket chamber to be discharged to the outside of the socket by the force of gravity.

In one embodiment, the downward movement of the piston may cause the socket to move upward by a certain height (i.e., a rocker arm moving-up height), and the rocker arm moving-up height may cause the clockwise rotation of the rocker arm by which the rocker arm gap formed by the profiles of the cam and the rocker arm is removed.

In one embodiment, the piston may form a piston chamber at the top of the piston, the piston chamber may form a space where the oil is filled, the piston chamber may be provided with a check valve, and the check valve may open and close the oil supply hole by the hydraulic action.

In one embodiment, the check valve may include a check plate and a check spring, the check plate may block or open the oil supply hole, and the check spring may elastically support the check plate with a spring elastic force smaller than the oil pressure.

In one embodiment, the piston may be provided with a clip having a C-shaped annular clip structure made of an elastic material, and the clip may be caught by a piston movement hole having a smaller diameter than that of the socket chamber of the socket inner space to prevent the piston from being separated from the socket.

In addition, in order to achieve the object, in accordance with another aspect of the present disclosure, a variable valve system includes a variable valve device in which oil is filled in a socket inner space of a socket by opening a check valve such that an oil pressure is generated in the socket inner space, and the generated oil pressure is configured to cause a piston to move downward by a rocker arm moving-up height from a bottom of the socket. The variable valve system further includes: a rocker arm device connected to the socket to supply the oil and configured to form a rocker arm gap with a cam having profiles of exhaust valve opening advance and exhaust valve closing retardation and a rocker arm and remove the rocker arm gap by a clockwise rotation due to the rocker arm moving-up height, a valve device configured to support the piston with an elastic force of a valve spring greater than an elastic force of a bias spring of the rocker arm device pressing down the variable valve device, and a controller configured to control the oil supply with a valve opening advance signal and a valve closing retardation signal.

As an embodiment, the rocker arm device may include a rocker arm configured to form the rocker arm gap with the elastic force of the bias spring and having a roller coming into contact with the profiles of the cam when the rocker arm gap is removed and a valve connection shaft connected to an oil circuit rocker arm shaft of the rocker arm and configured to supply the oil to a socket flow path communicating with the socket, and the valve connection shaft may form a funnel end coming into close contact with a funnel shape of an oil supply hole formed in the socket.

As another embodiment, the valve device may include a valve bridge configured to support the piston in a state of coming into surface contact with the bottom of the piston, and the valve bridge may be connected to an exhaust valve coupled to the valve spring.

The piston-operated variable valve device applied to the variable valve system according to the present disclosure implements the following actions and effects.

First, since the motion of the rocker arm for the contact with the cam profiles is caused by the movement of the piston lifting the rocker arm, it is possible to implement the opening advance and closing retardation of the variable valve technique without separately adding the cam and the rocker arm. Second, it is possible to maximize the increase in the exhaust gas in the single overhead camshaft (SOHC) vehicle by following the cam profiles of the rocker arm by the movement of the piston to implement the opening advance and the closing retardation at the same time. Third, since the oil is discharged naturally without separate oil discharge valve when the piston is returned after the variable operation of the opening advance and the closing retardation, it is possible to simplify the components and decrease the cost by deleting the relief valve without the impact due to the variability. Fourth, it is possible to decrease the cost by decreasing the number of components, saving the material cost, and decreasing the weight compared to the conventional variable valve device and quickly increase the exhaust temperature with the improved performance, and thus it is easy to respond to emission gas regulations by satisfying the catalyst activation temperature. Fifth, by applying the variable valve device to large commercial engines, it is possible to prevent the increase in the price of the catalyst for responding to the exhaust regulations and in particular, improve vehicle merchantability by decreasing the harmful emission gas.

### BRIEF DESCRIPTION OF THE DRAWINGS

FIG. 1 is a configuration diagram of a piston-operated variable valve device applied to a variable valve system according to an embodiment of the present disclosure.

FIG. 2 is a perspective view of the variable valve device, a rocker arm device, and a valve device according to an embodiment of the present disclosure.

FIG. 3 is a detailed configuration diagram of the piston-operated variable valve device according to an embodiment of the present disclosure.

FIG. 4 is an operation example in which the variable valve system according to the present disclosure implements a variable operation of opening advance and closing retardation with the piston-operated variable valve device.

FIG. 5 is an operation example in which the piston-operated variable valve device according to the present disclosure returns to an initial state by naturally discharging internal oil when the variable operation is stopped.

### DETAILED DESCRIPTION

Hereinafter, an embodiment of the present disclosure is described in detail with reference to the accompanying exemplary drawings, and the embodiment may be implemented in various different forms by those having ordinary skill in the art to which the present disclosure pertains as an example and is not limited to the embodiment described herein.

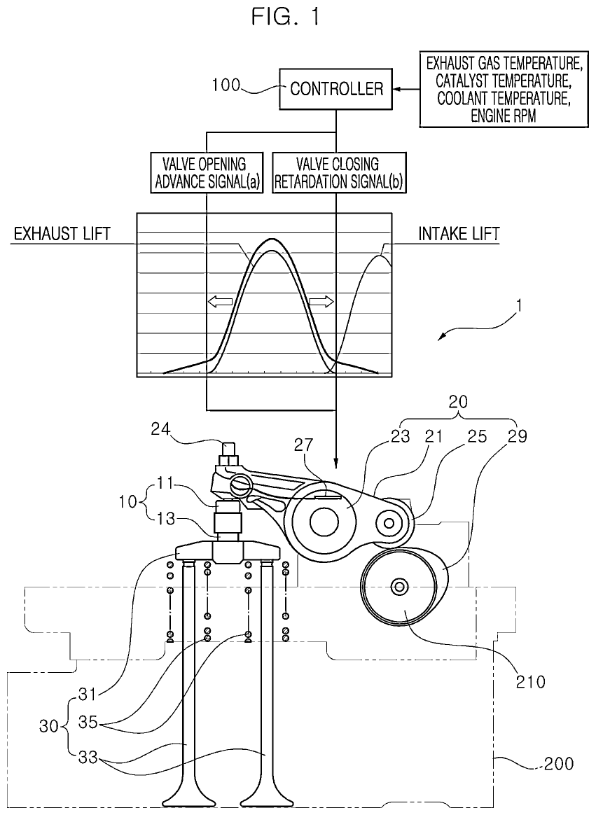

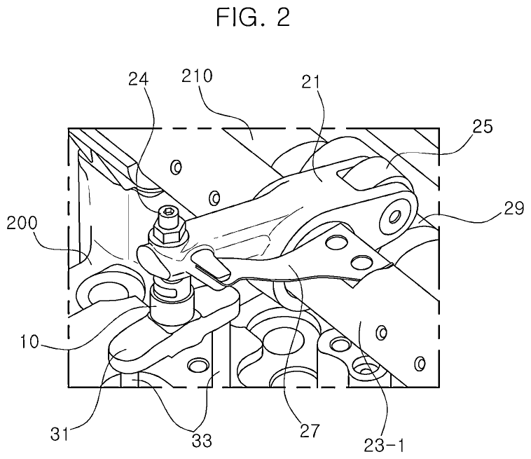

Referring to FIGS. 1 and 2, a variable valve system 1 includes a variable valve device 10, a rocker arm device 20 configured to shift valve profiles according to an operation of the variable valve device 10, and a valve device 30 which is advanced or retarded according to the movement of the valve profiles of the rocker arm device 20.

Specifically, the variable valve device 10 is characterized by a piston pop up type variable valve mechanism, in which oil is supplied to an inner space of a socket 11 coupled to a valve connection shaft 24 of a rocker arm 21, a piston 13 is popped up to protrude from the socket 11 in a state of being seated on an upper surface of a valve bridge 31. In particular, the pop up motion (i.e., downward motion) of the piston 13, relative to the socket 11, by a hydraulic action causes one end of the rocker arm 21 to move upward so that a roller 25 provided at the other end of the rocker arm 21 comes into contact with cam profiles of a cam 29.

Therefore, the pop up motion of the piston 13 causes the rocker arm 21 coming into contact with the cam 29 via the roller 25 to follow the cam profile, thereby implementing exhaust valve opening advance and exhaust valve closing retardation of the rocker arm 21 with respect to the valve (i.e., an exhaust valve 33). In this case, the exhaust valve opening advance effect brings an increase in exhaust temperature due to the discharge of high-temperature combustion gas during an explosion stroke, and the exhaust valve closing retardation effect increases an intake temperature due to an increase in a flow rate of an internal exhaust gas recirculation (EGR), thereby contributing to increase the exhaust temperature.

In particular, the pop up motion of the piston 13 enables the rocker arm 21 to be retarded after advanced, thereby maximizing the increase in the exhaust temperature.

To this end, the variable valve device 10 is connected to a controller 100 configured to output a valve opening advance signal “a” and a valve closing retardation signal “b”, and the controller 100 controls an oil control valve (OCV) with engine data according to an operation of an engine 200 in an engine operation condition in which advance and retardation are required so that engine oil introduced from an oil supply passage 23-1 (see FIG. 2) into the oil control circuit of the rocker arm device 20 is supplied toward the socket 11 of the variable valve device 10 through a valve connection shaft 24. In this case, the engine data of the controller 100 includes an exhaust gas temperature, a catalyst temperature, a coolant temperature, an engine RPM, and the like.

Specifically, the rocker arm device 20 includes the rocker arm 21, an oil circuit rocker arm shaft 23, the valve connection shaft 24, the roller 25, a bias spring 27, and the cam 29.

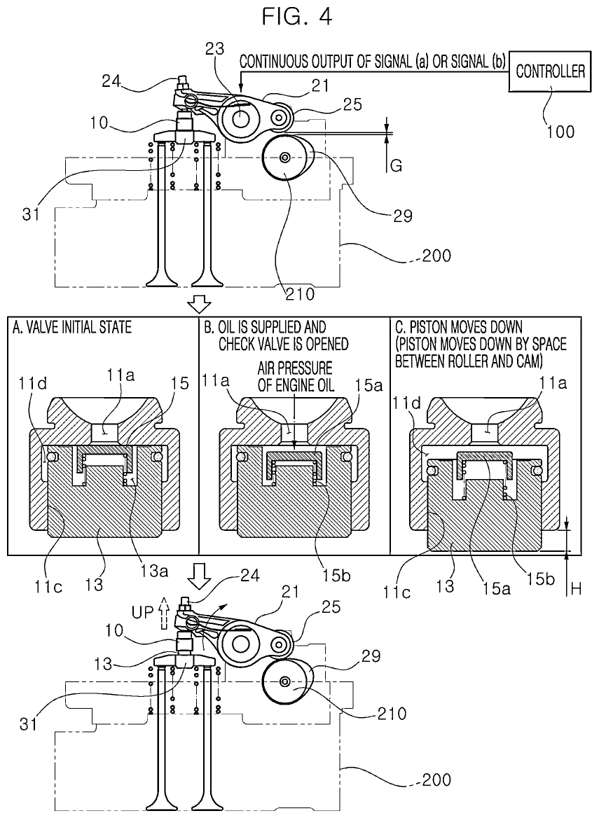

In one embodiment, the rocker arm 21 is mounted on the engine 200 (i.e., a cylinder head), and a rocker arm gap G (see FIG. 4) between the roller 25 and the cam 29 is formed or removed by a seesaw motion about the oil circuit rocker arm shaft 23.

In another embodiment, the oil circuit rocker arm shaft 23 includes the oil control circuit which is formed inside the rocker arm shaft and controlled by the OCV. The oil circuit rocker arm shaft 23 is arranged in parallel with a cam shaft 210 of the engine 200 to pass through the rocker arm 21 and functions as the center of the seesaw motion.

In particular, the oil control circuit of the oil circuit rocker arm shaft 23 communicates with the oil supply passage 23-1 (see FIG. 2) through which the engine oil is supplied. In this case, the oil supply passage 23-1 functions as an oil line directly connected from an engine oil main gallery and an oil pump to a cylinder block or cylinder head of the engine 200.

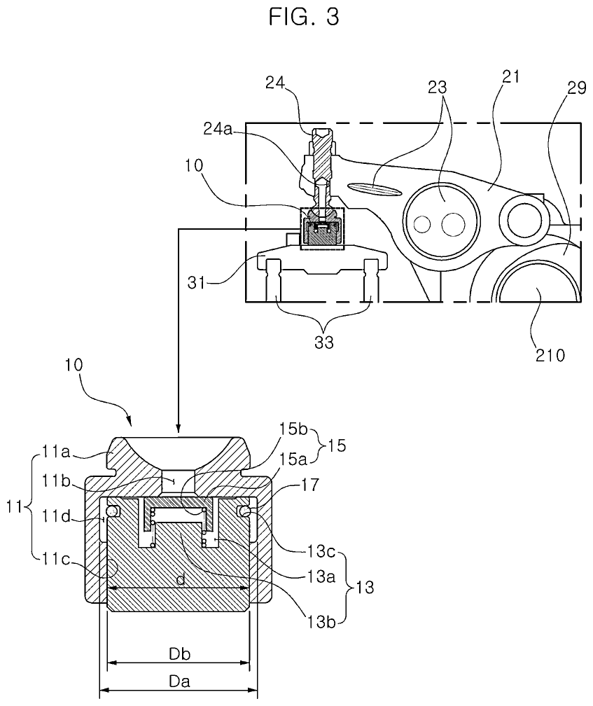

For example, the valve connection shaft 24 is fixed to one end of the rocker arm 21 (i.e., a direction opposite to the roller 25) and forms a socket flow path 24a (see FIG. 3) inside the shaft to be connected to the oil control circuit of the oil circuit rocker arm shaft 23. The socket 11 of the variable valve device 10 is coupled and fixed to an edge of the valve connection shaft 24. In this case, the oil control circuit communicates with the socket flow path 24a through an oil path hole formed in a rocker arm body of the rocker arm 21.

In particular, the valve connection shaft 24 forms a funnel end and comes into close contact with a funnel-shaped oil supply hole 11b (see FIG. 3) of the socket 11.

For example, the roller 25 is pinned to the other end of the rocker arm 21 (i.e., a direction opposite to the valve connection shaft 24) to form the rocker arm gap G (see FIG. 4) with the cam 29 and moves down toward the cam 29 upon the seesaw motion of the rocker arm 21 to remove the rocker arm gap G, and thus form the contact state with the cam 29.

In one embodiment, a bias spring 27 presses down the valve connection shaft 24 by a spring elastic force in a state of being fixed to an outer diameter of the oil circuit rocker arm shaft 23 with one end of the rocker arm 21 (i.e., toward the valve connection shaft 24) so that the roller 25 forms the rocker arm gap G (see FIG. 4) with the cam 29. In this case, the bias spring 27 is a leaf spring and generates a smaller force than a force of a valve spring 35 of the valve device 30.

For example, the cam 29 has cam profiles for the exhaust valve opening advance and the exhaust valve closing retardation such that the roller 25 comes into contact and is coupled to the cam shaft 210.

Specifically, the valve device 30 includes a valve bridge 31, the exhaust valve 33, and the valve spring 35.

For example, the valve bridge 31 has the piston 13 of the variable valve device 10 seated on an upper surface at a central position thereof and maintains a fixed state of the valve bridge 31 from a force applied by the piston 13 when the piston 13 is popped up so that the socket 11 functions to move up the valve connection shaft 24.

In one embodiment, the exhaust valve 33 is comprised of two valves, i.e., a left exhaust valve and a right exhaust valve, coupled to the valve bridge 31 at an interval to open and close a combustion chamber of the engine 200 by a valve “LIFT” and implements the valve LIFT with the exhaust valve opening advance and the exhaust valve closing retardation upon operation of the rocker arm 21.

For example, the valve spring 35 is coupled to each of the left exhaust valve and the right exhaust valve of the exhaust valve 33 to apply the spring elastic force when the valve returns. In this case, the valve spring 35 is a coil spring and generates a greater spring force than the force of the bias spring 27.

Referring to FIG. 3, the variable valve device 10 includes the socket 11, the piston 13, the rocker arm 21, and the cam 29 having profiles with different opening and closing timings of the exhaust valve. The piston 13 vertically moves by an oil pressure of the oil supplied to the inside of the socket 11, the exhaust valve 33 is opened and closed by the predetermined cam profile, i.e., the exhaust valve 33 connected to the valve bridge 31 is opened and closed by the predetermined cam profiles of the cam 29 when the piston 13 protrudes downward from the socket 11 to cause the rocker arm 21 to contact with the cam 29.

Specifically, the socket 11 is formed in a cylindrical body having a predetermined length divided into a shaft connection upper portion and a piston accommodation lower portion, wherein the shaft connection upper portion is formed as a shaft connection portion 11a in which the oil supply hole 11b is formed, and the piston accommodation lower portion forms a socket inner space with a piston movement hole 11c and a socket chamber 11d communicating with the oil supply hole 11b. In this case, the shaft connection upper portion and the piston accommodation lower portion form a cylindrical body as a double concentric body with a difference in diameter.

For example, the oil supply hole 11b has a funnel-shaped open structure in the shaft connection portion 11a and communicates with the socket inner space, and the funnel shape transmits the oil output from the socket flow path 24a to the socket chamber 11d of the socket inner space in a state of being coupled to the funnel end of the valve connection shaft 24.

For example, the piston movement hole 11c forms a cylindrical open structure with an insertion diameter Db in which the piston 13 is accommodated, and the socket chamber 11d communicates with the oil supply hole 11b while expanding the socket inner space with an expansion diameter Da in an upper section of the piston movement hole 11c. In this case, the expansion diameter Da is formed to be about 110 to 120% of the insertion diameter Db, but a diameter difference (Da-Db) may be set variously depending on the oil flow rate which enables the pop up motion of the piston 13 by the hydraulic action.

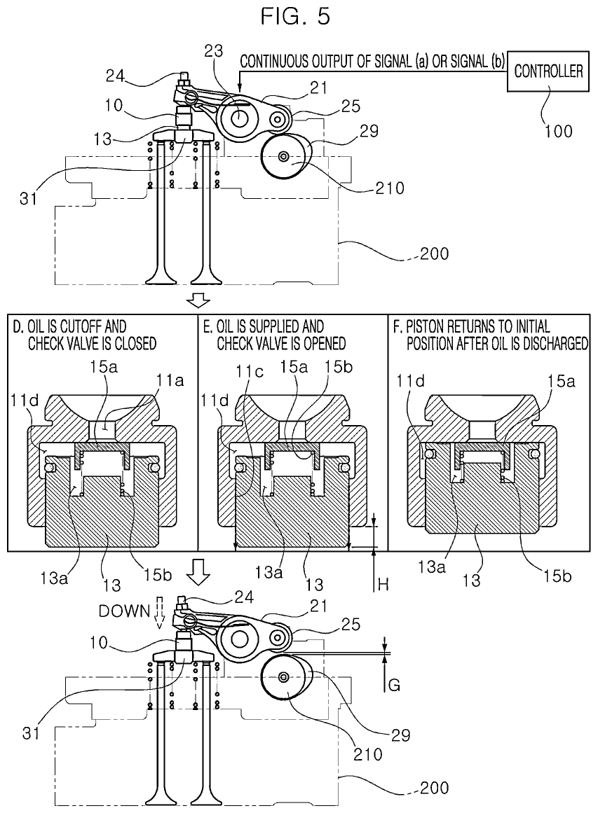

In particular, the insertion diameter Db has a minute diameter difference (e.g., several tens to several hundred μm) with the piston diameter d and a gap (Db-d) of the piston 13, and the gap of the diameter difference allows the oil filling the socket chamber 11d to be discharged to the outside of the socket by the action of gravity (see FIG. 5) when no oil is supplied.

Specifically, the piston 13 includes a piston chamber 13a, a chamber protrusion 13b, and a clip groove 13c.

For example, the piston chamber 13a is formed in an open structure which is recessed in a “U” cross-sectional shape in an upper surface of the piston and filled with oil, and the chamber protrusion 13b protrudes concentrically from a bottom surface having a “U” cross-sectional shape of the piston chamber 13a so that a check spring 15b of a check valve 15 is coupled. In this case, the “U” cross-sectional shape forms an expanded circumference of the upper surface of the piston recessed to a predetermined depth on the top, and a height of the chamber protrusion 13b is formed within about 30 to 40% of the depth of the piston chamber 13a.

For example, the clip groove 13c is formed as an annular groove recessed in an outer diameter of the piston on the top of the piston 13 to couple a clip 17, and the clip 17 passes through the oil supply hole 11b of the socket 11 together with the piston 13 in a state of being fitted into the clip groove 13c in a compressed state and then is restored in the space of the socket chamber 11d and caught by the piston movement hole 11c, thereby preventing the piston 13 from being separated from the socket 11 when the piston 13 is popped up. In this case, the clip 17 has a C-shaped annular clip structure made of an elastic material.

Furthermore, the variable valve device 10 further includes the check valve 15 and the clip 17 connected with the piston 13 in the inner space of the socket 11.

Specifically, the check valve 15 is comprised of a check plate 15a and a check spring 15b, wherein the check plate 15a has a “U” shape to block the oil supply hole 11b of the socket 11 when the oil is not supplied, and the check spring 15b pushes the check plate 15a toward the oil supply hole 11b as an initial state when the oil is not supplied. In this case, as the check spring 15b, a coil spring is applied, and the spring elastic force is set to be smaller than the oil pressure, which is the hydraulic action of oil.

In particular, the check plate 15a has a smaller diameter than a diameter of the piston chamber 13a so that the oil is introduced into the piston chamber 13a, and the check spring 15b is compressed and transformed by the movement of the check plate 15a moving down by receiving the hydraulic action applied by the oil pressure of the oil according to the oil supply.

FIGS. 4 and 5 show operating states of the variable valve device 10 for the exhaust valve opening advance and the exhaust valve closing retardation. In this case, the operation of the variable valve device 10 is described mainly about the socket 11 connected to the rocker arm 21 forming the rocker arm gap G with the cam 29 having the profiles of the exhaust valve opening advance and the exhaust valve closing retardation and formed with the socket inner space communicating with the oil supply hole 11b receiving the oil from the rocker arm 21 and the piston 13 in which the contact state of the valve bridge 31 to which the exhaust valve 33 is fixed is maintained. the downward movement of the piston is caused by the oil pressure of the oil filling the socket inner space, and the downward movement causes the socket to move upward by a certain height (hereinafter “a rocker arm moving-up height H”) i.e., protruding from the bottom of the socket 11, and the rocker arm moving-up height H causes the clockwise rotation of the rocker arm 21 by which the rocker arm gap G is removed.

Referring to FIG. 4, the variable valve device 10 when the rocker arm 21 is operated, the variable valve device 10 starts to operate by outputs of a valve opening advance signal “a” and/or a valve closing retardation signal “b” from the controller 100. In this case, the controller 100 controls the OCV under the engine operation conditions which require the advance or retardation of the exhaust valve 33 from the engine data, such as an exhaust gas temperature, a catalyst temperature, a coolant temperature, and an engine RPM, according to the operation of the engine 200, which is a basic operating method of the variable valve system 1.

Then, the rocker arm 21 transmits the engine oil of the oil supply passage 23-1 (see FIG. 2) to the valve connection shaft 24 through the oil path hole of the rocker arm body connected to the oil control circuit of the oil circuit rocker arm shaft 23, and the valve connection shaft 24 transmits the engine oil from the socket flow path 24a toward the socket 11 of the variable valve device 10.

Therefore, the variable valve device 10 causes the pop up motion of the piston 13 by operating sequentially in a valve initial state (A)->a state in which the oil is supplied and the check valve is opened (B)->a state in which the piston moves down (C). In this case, “->” is the progress order of the operation.

For example, the valve initial state (A) is a state in which there is no oil is supplied to the socket 11 and thus the piston 13 has completely entered into the inner space of the socket, and at the same time, a state in which the check valve 15 is an initial state and block the oil supply hole 11b of the socket 11.

Subsequently, in the oil supply and check valve open state (B), the oil introduced into the oil supply hole 11b of the socket 11 by the operation of the rocker arm 21 presses the check plate 15a of the check valve 15, and the check plate 15a compresses the check spring 15b while moving down due to the increase in the amount of introduced oil and thus the check valve 15 is opened.

Finally, in the piston moving-down state (C), the socket chamber 11d and the piston chamber 13a, which are oil chambers, are completely filled with oil, and thus the movement of the piston 13 subjected to the hydraulic action of the oil is caused in a state in which the piston 13 comes into contact with an upper surface of the valve bridge 31, and the piston 13 comes out of the socket 11 by a certain length or height, i.e., the rocker arm moving-up height H, and thus the rocker arm 21 moves up by the rocker arm moving-up height H. In this case, the force (i.e., the spring elastic force) of the valve spring 35 configured to support the valve bridge 31 coming into surface contact with the piston 13 acts greater than the force (i.e., the spring elastic force) of the bias spring 27 pressing down the rocker arm 21, and thus when the piston 13 comes from the socket 11 to the rocker arm moving-up height H by the oil pressure, the valve bridge 31 side does not move and the rocker arm 21 may cause the clockwise rotation through the oil circuit rocker arm shaft 23.

As a result, the socket 11 overcomes a pressing force of the bias spring 27 and moves up the valve connection shaft 24 of the rocker arm 21, and thus the rocker arm 21 removes the rocker arm gap G between the roller 25 and the cam 29 by the clockwise rotation of the seesaw motion about the oil circuit rocker arm shaft 23, and the rocker arm 21 operates the exhaust valve 33 by the motion of the roller 25 following the cam profiles of the cam 29 so that the exhaust valve 33 is operated by the valve opening advance or the valve closing retardation.

On the other hand, referring to the variable valve device 10 when the operation of the rocker arm 21 returns in FIG. 5, the variable valve device 10 starts the returning operation by stopping the outputs of the valve open advance signal a and/or the valve closing retardation signal b of the controller 100.

Then, the rocker arm 21 stops the oil supply through the oil supply path 23-1, the oil circuit rocker arm shaft 23, and the socket flow path 24a of the valve connection shaft 24, and thus the oil supply to the socket 11 is also stopped.

Therefore, the variable valve device 10 operates sequentially in a state in which the oil is cutoff and the check valve is closed (D)->a state in which the oil in the socket is naturally discharged after the oil is cut off (E)->a state in which the oil is completely discharged (F), and thus the piston 13 switches to a state in which the piston returns to the initial position. In this case, “->” is the progress order of the operation.

For example, in the state in which the oil is cutoff and the check valve is closed (D), the oil supply to the socket 11 is stopped in the state in which the piston 13 comes to the piston pop up height H, and thus the check plate 15a of the check valve 15 blocks the oil supply hole 11b of the socket 11 by a spring restoring force of the check spring 15b.

Subsequently, in the state in which the oil in the socket is naturally discharged after the oil is cut off (E), the oil filled in the socket chamber 11d of the socket inner space and the piston chamber 13a is naturally discharged (i.e., discharged by the action of gravity) through the gap (Db-d) which is a difference between the insertion diameter Db and the piston diameter d so that the hydraulic action of the oil to the piston 13 is gradually weakened and removed.

Finally, in the state in which the oil is completely discharged (F), the hydraulic action is released by fully discharging the oil from the socket chamber 11d and the piston chamber 13a which are the oil chambers, and thus the rocker arm 21 moves down by the seesaw motion in the clockwise direction by the force applied by the bias spring 27, and the downward movement of the rocker arm 21 causes the piston 13 to insert into the socket inner space to remove the rocker arm moving-up height H. In this case, the force of the bias spring 27 is smaller than the force of the valve spring 35, and thus the valve bridge 31 maintains the contact state with the piston 13.

As a result, the socket 11 and the piston 13 return to the initial states, and the rocker arm 21 returns to the initial state by forming the rocker arm gap G between the roller 25 and the cam 29, and thus the exhaust valve 33 is operated by the normal valve LIFT (see FIG. 1) without valve opening advance or valve closing retardation.

As described above, the variable valve system 1 according to the embodiment includes the variable valve device 10 in which the oil is filled in the socket inner space of the socket 11 by opening the check valve 15, the downward motion of the piston 13 is caused by the oil pressure and thus the piston 13 protrudes from the bottom of the socket 11 by the rocker arm moving-up height H, and the rocker arm gap G forming with the cam 29 having the cam profiles of the exhaust valve opening advance and the exhaust valve closing retardation by rotating the rocker arm 21 to the rocker arm moving-up height H clockwise is removed, and thus it is possible to maximum the increase in the exhaust temperature in the specific operation condition by continuously implementing the opening advance and the closing retardation of the rocker arm 21 in the downward movement state of the piston 13, and in particular, significantly decrease the cost increase factors without additionally constituting the cam and the rocker arm by naturally discharging the oil causing the pop up motion of the piston by the action of gravity in the socket inner space even without separate relief valve.

What is claimed is:

1. A variable valve device comprising: a cam having profiles with different exhaust valve opening and closing timings, a rocker arm, and a socket having a piston,
wherein an exhaust valve is connected to a valve bridge,
the piston vertically moves by oil pressure supplied to an inside of the socket, and
when the piston protrudes downward from the socket, the rocker arm and the cam come into contact with each other, and the exhaust valve is opened and closed by the cam profiles.

2. The variable valve device of claim 1, wherein the oil pressure is set to be greater than an elastic force of a bias spring pressing the rocker arm and smaller than an elastic force of a valve spring configured to support the valve bridge.

3. The variable valve device of claim 1, wherein the socket forms a socket inner space in which the oil pressure is generated.

4. The variable valve device of claim 3, wherein the socket inner space is divided into an oil supply hole receiving the oil from the rocker arm, a piston movement hole, and a socket chamber,
the piston movement hole functions as a passage into which the piston is inserted, and
the socket chamber forms a space in which the oil pressure is generated by communicating with the oil supply hole, and the piston receives the oil pressure such that the piston moves downward from the socket.

5. The variable valve device of claim 4, wherein the oil supply hole has a funnel-shaped open structure and communicates with the socket chamber.

6. The variable valve device of claim 4, wherein the socket chamber is formed with a diameter greater than a diameter of the piston movement hole, and
the socket chamber communicates with the oil supply hole formed at a top of the piston movement hole.

7. The variable valve device of claim 4, wherein the piston movement hole forms a gap with the piston, and
the gap functions to allow the oil filled in the socket chamber to be discharged to an outside of the socket by a force of gravity.

8. The variable valve device of claim 4, wherein the downward movement of the piston causes the socket to move upward, and
the upward movement of the socket causes the rocker arm to rotate in a clockwise direction such that a rocker arm gap between the profiles of the cam and the rocker arm is removed.

9. The variable valve device of claim 4, wherein the piston forms a piston chamber at a top of the piston, and
the piston chamber forms a space where the oil is filled.

10. The variable valve device of claim 9, wherein the piston chamber is provided with a check valve, and
the check valve opens and closes the oil supply hole by receiving the oil pressure.

11. The variable valve device of claim 10, wherein the check valve includes a check plate and a check spring,
the check plate blocks or opens the oil supply hole, and
the check spring elastically supports the check plate.

12. The variable valve device of claim 11, wherein an elastic force of the check spring is set to be smaller than the oil pressure.

13. The variable valve device of claim 1, wherein the piston is provided with a clip, and
the clip is caught by a piston movement hole having a diameter smaller than a diameter of a socket chamber of the socket to prevent the piston from being separated from the socket.

14. The variable valve device of claim 13, wherein the clip has a C-shaped annular clip structure made of an elastic material.

15. A variable valve system comprising:
a variable valve device in which oil is filled in a socket inner space of a socket by opening a check valve such that an oil pressure is generated in the socket inner space, the generated oil pressure configured to cause a piston to move downward by a rocker arm moving-up height from a bottom of the socket;
a rocker arm device connected to the socket to supply the oil and configured to form a rocker arm gap with a cam having profiles of exhaust valve opening advance and exhaust valve closing retardation and a rocker arm and remove the rocker arm gap by a clockwise rotation due to the rocker arm moving-up height;
a valve device configured to support the piston with an elastic force of a valve spring greater than an elastic force of a bias spring of the rocker arm device pressing down the variable valve device; and
a controller configured to control the oil supply with a valve opening advance signal and a valve closing retardation signal.

16. The variable valve system of claim 15, wherein the rocker arm device includes
a rocker arm configured to form the rocker arm gap with the elastic force of the bias spring and having a roller coming into contact with the profiles of the cam when the rocker arm gap is removed, and
a valve connection shaft connected to an oil circuit rocker arm shaft of the rocker arm and configured to supply the oil to a socket flow path communicating with the socket.

17. The variable valve system of claim 16, wherein the valve connection shaft forms a funnel end coming into close contact with an oil supply hole formed in the socket.

18. The variable valve system of claim 15, wherein the valve device includes a valve bridge configured to support the piston in a state of coming into surface contact with a bottom of the piston, and
the valve bridge is connected to an exhaust valve coupled to the valve spring.
